(19) United States
(12) Patent Application Publication
(10) Pub. No.: US 2004/0094016 A1
(43) Pub. Date: May 20, 2004

(54) Cymbal retainer

(76) Inventor: Dale A. Hallerberg, Lake Barrington, IL (US)

Correspondence Address: DALE HALLERBERG, 15 OLD BARRINGTON ROAD, LAKE BARRINGTON, IL, 60010, US

(21) Appl. No.: 10/293,999

(22) Filed: Nov. 14, 2002

(51) Int. Cl. G10D 13/02

(52) U.S. Cl. 84/422.3

(57) ABSTRACT

A one-piece retainer for a cymbal on a stand. The essence of the invention is a one-piece retainer secured to the cymbal rod. The unit employs a plastic, cylindrical sleeve to mount to a threaded cymbal rod, with spring fingers which are compressed as the cymbal is pushed onto the cymbal support. The spring fingers then release to their original position when the cymbal is fully in place, and act to prevent the cymbal from coming off the cymbal support.

### BACKGROUND OF THE INVENTION

1. Field of the Invention

This invention is an improvement on the method of securing cymbals used in percussion performances to their stands. The cymbal retainer of this invention is a one-piece device designed to replace the present multiple-component devices used for keeping the cymbal on a stand. The cymbal retainer of this invention is designed to simplify and speed up the mounting and dismounting of cymbals, and to make attachment of the retainer fast and secure.

2. Description of Prior Art

As shown in FIG. 4 the present cymbal stands generally utilized throughout the music industry employ a cymbal rod 3 at their upper extremity. The top portion of this cymbal rod is usually threaded 3a. There is an oversized stop 3b at the base of the rod over which is fitted a curved metal washer 5. A felt washer 4 usually rests on the metal washer and the cymbal rod is usually covered by a plastic sleeve. The cymbal fits over the rod and the sleeve by virtue of a center hole in the cymbal. Finally, a wing nut is tightened onto the top, threaded portion of the rod in order to keep the cymbal from coming off the rod.

Some modified devices which eliminate the wing nut securement have been developed and patented; such as, Cordes, U.S. Pat. No. 3,705,528; Gaylor, U.S. Pat. No. 3,336,827; and Herman U.S. Pat. No. 3,994,198.

### BRIEF SUMMARY OF THE INVENTION

The cymbal retainer of this invention is a one-piece device for screwing onto a cymbal rod for receiving and supporting a cymbal. The device generally consists of a plastic cylindrical sleeve which is screwed onto the cymbal rod utilizing an integral hex head on the top end of the device. One or more extensions project down and away from the top of the sleeve, forming flexible fingers which will be temporarily compressed back toward the cymbal rod when the cymbal is pushed over the rod. The extensions then return to their original position to retain the cymbal on the stand. In order to remove the cymbal, the extensions are bent toward the cymbal rod and the cymbal can then be slid off the cymbal rod.

One of the principal objects of the invention was to replace the wing nut used on conventional cymbal stands because of the tendency for the wing nuts to be lost, or to loosen during a performance and drop on the cymbal, making unintended noise. Another object was to make the device so that the cymbal could be quickly and easily mounted and dismounted.

The device is advantageous because it is sized to be used with existing cymbal stands. The device has features which make it easy to mount to the cymbal stand by hand or with readily available tools. The device includes a feature which assures that it remains secure once it is mounted on the cymbal stand.

Other objects and advantages will, undoubtedly, be apparent to those skilled in the art from a review of the specification, claims, and a study of the attached drawings.

### BRIEF DESCRIPTION OF THE DRAWINGS

FIG. 1 is a perspective view of the device mounted on a cymbal stand supporting and retaining a cymbal in the playing position.

FIG. 2 is a perspective view of the device.

FIG. 3 is a cross section of the assembled device.

FIG. 4 shows a cymbal and cymbal stand combination of the prior art.

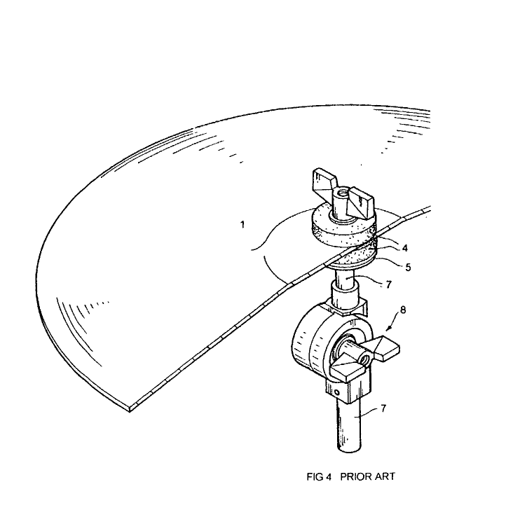

### DETAILED DESCRIPTION OF THE INVENTION

The preferred embodiment is constructed of durable plastic. The device might be injection molded or constructed of several independent parts glued or heat welded together.

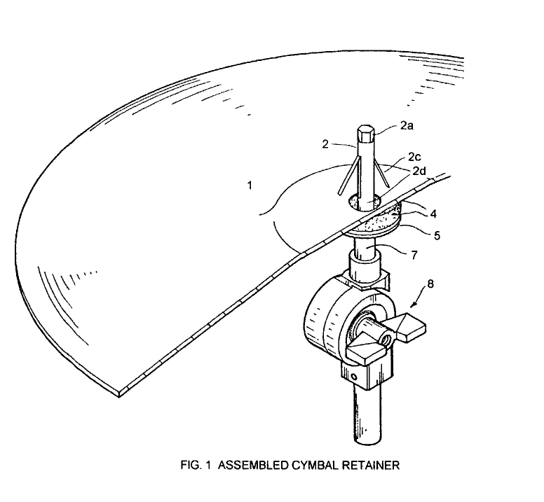

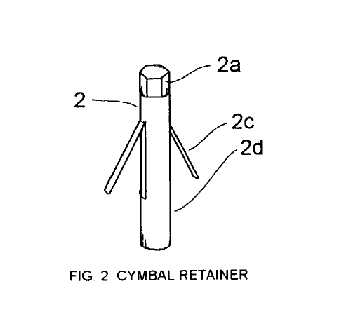

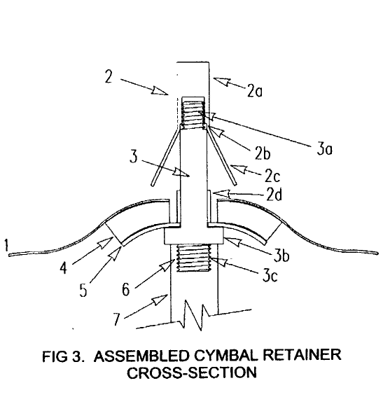

Details of the unique construction of the cymbal retainer 2 are illustrated in FIGS. 1, 2, and 3.

The device of this invention is designed to be mounted on a conventional cymbal stand 7. The cymbal stand 7 includes an internally threaded top portion 6. The cymbal stand may optionally include an adjustable elbow 8. The top portion of the cymbal stand holds the cymbal rod 3 by threaded engagement of the cymbal rod base 3c. The cymbal rod 3 has an integral stop 3b and the top portion of the cymbal rod is threaded 3a. The cymbal rod stop 3b holds the support washer 5 which in turn supports the felt washer 4.

The cymbal retainer 2 is comprised of several portions. The base 2d of the cymbal retainer 2 is a cylindrical sleeve sized to fit around the cymbal rod. The spring finger(s) 2c extend down and away from the top portion of the cymbal retainer. These spring fingers are bendable but stiff, returning to their original position after being compressed axially toward the cymbal rod 3. The inside neck 2b of the cymbal retainer 2 is sized in length, placement, and shape to fit tight as it is screwed down onto the cymbal rod threads 3a. The cymbal retainer head 2a has an external shape which mates with a hexagonal nutdriver.

A preferred modification of this device is shaping the cymbal retainer head 2a to mate with a conventional drum tuning key. This may be included in combination with other tightening means.

A preferred modification of this device is including a straight screwdriver slot in the cymbal retainer head 2a to allow use of a conventional screwdriver for tightening the cymbal retainer onto the cymbal rod. This may be included in combination with other tightening means.

A preferred modification of this device is including a recess in the cymbal retainer head 2a to allow use of a Phillips screwdriver for tightening the cymbal retainer onto the cymbal rod. This may be included in combination with other tightening means.

A preferred modification of this device is including a recess in the cymbal retainer head 2a to allow use of a square-drive type screwdriver for tightening the cymbal retainer onto the cymbal rod. This may be included in combination with the hexagonal outer shape of the cymbal retainer head 2a, and/or the other tightening means.

A preferred modification of this device is including a recess in the cymbal retainer head 2a to allow use of a hexagonal Allen-wrench for tightening the cymbal retainer onto the cymbal rod. This may be included in combination with the hexagonal outer shape of the cymbal retainer head 2a, and/or the other tightening means.

A preferred modification of this device is including a knurled outside surface of cymbal retainer head 2a to to use as a grip for tightening by hand. This may be included in combination with other tightening means.

A preferred modification of this device is to include a plastic washer at the base of the cylindrical sleeve. This modification allows the cymbal retainer to be used without a felt washer which is advantageous for outdoor performances where occaisional rain might damage the felt washer.

A preferred modification of this device is to include a conically flared portion at the base of the cylindrical sleeve 2d. This modification reduces the amount of swing when the cymbal is struck.

### OPERATION OF THE DEVICE

The cymbal retainer 2 is placed over the cymbal rod 3 and screwed onto the cymbal rod threads 3a. The inside diameter of the cymbal retainer 2b is shaped to thread tightly to the cymbal rod threads 3a and not be easily loosened by the movement of the cymbal during use.

Most cymbals throughout the industry have a ½ inch diameter support cymbal hole. The cymbal 1, accordingly, readily slips over the head 2a of the cymbal retainer 2 and the cymbal 1 compresses the spring finger(s) 2c, finally coming to rest on the felt washer 4 supported by the curved washer 5 supported by the cymbal rod base 3b. After the cymbal has passed the spring finger(s) 2c, they spring back to their original position.

During normal performance, the cymbal is struck by the drummer and will naturally rock up and down. The spring finger(s) 2c retains the cymbal 1 from bouncing off the cymbal rod 3. The cylindrical sleeve 2d of the cymbal retainer prevents the cymbal from directly contacting the cymbal rod 3, thus preventing metal-on-metal contact and the poor sound and abrasion which would result.

Following the conclusion of the performance, the spring finger(s) 2c are compressed axially by hand, and the cymbal 1 is lifted off the cymbal rod 3. The cymbal retainer 2 is intended to stay on the cymbal stand permanently, and will retain the felt washer 4 and curved washer 5 until the next use.

Having described the construction of the device of this invention in detail, what is desired to be claimed is all modifications of the device not departing from the scope of equivalents of the invention as defined in the appended claims. Although the present invention has been described in relation to particular embodiments thereof, many other variations and modifications and other uses will become apparent to those skilled in the art. It is preferred, therefore, that the present invention be limited not by the specific disclosure herein, but only by the appended claims.

I claim:

1. A one-piece cymbal retainer comprising:
a cylindrical sleeve of plastic material,
a flexible extension beginning at the upper potion of said sleeve and extending downward and outward from the sleeve,
a reduced inside diameter portion of the sleeve in the upper portion of said sleeve, sized to act as a locking nut for the threaded portion of the cymbal rod,
a hexagonal external shape at the upper end of said sleeve, suitable for mating to a nutdriver or similar tool.

2. The invention of claim 1 further comprising additional flexible extensions beginning at the upper portion of said sleeve and extending downward and outward from the sleeve.

3. The invention of claim 1 with a 4-sided external shape at the upper end of the device, suitable for mating to a conventional drum tuning key.

4. The invention of claim 1 with a screwdriver slot in the upper end of the device, suitable for mating to a straight screwdriver or similar tool.

5. The invention of claim 1 with a recess in the upper end of the device, suitable for mating to a Phillips-head screwdriver.

6. The invention of claim 1 with a recess in the upper end of the device, suitable for mating to a square-drive screwdriver or similar tool.

7. The invention of claim 1 with a recess in the upper end of the device, suitable for mating to a hexagonal Allen wrench or similar tool.

8. The invention of claim 1 with a knurled outside surface on the upper end of the device, to use as a grip for tightening by hand.

9. The invention of claim 1 further comprising a circular washer at the base of the cylindrical sleeve,

10. The invention of claim 1 further comprising a conically flared portion at the base of the cylindrical sleeve.
